(19) United States
(12) Patent Application Publication
(10) Pub. No.: US 2010/0215212 A1
(43) Pub. Date: Aug. 26, 2010

(54) System and Method for the Inspection of Structures

(75) Inventor: Malcolm S. Flakes, JR., St. Petersburg, FL (US)

Correspondence Address: HONEYWELL/S&S;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/393,540

(22) Filed: Feb. 26, 2009

(51) Int. Cl. G06K 9/00; H04N 7/18

(52) U.S. Cl. 382/100; 348/144; 348/E07.085

(57) ABSTRACT

A system and method utilizing an unmanned air vehicle to inspect structures is disclosed. An unmanned air vehicle capable of moving to a position and hovering in place is positioned using GPS coordinates. The unmanned air vehicle is able to capture images of the structure and transmit the images to an inspector and a database. Data identifying the position of the unmanned air vehicle and the orientation of the digital camera can be stored in the database, permitting specific inspections of specific structural elements to be repeated with a high degree of precision and accuracy later in time.

### FIELD OF INVENTION

The present application relates generally to unmanned air vehicles (UAVs), and methods systems for using UAVs in the inspection of buildings and other structures.

### BACKGROUND

The inspection of bridges, highway overpasses, high-rise buildings, and other public and private structures is important in maintaining public safety. Undetected wear and structural defects in bridges can lead to disastrous failures and collapses. Even minor structural defects on bridges and other thoroughfares can cause significant disruptions in traffic flow and slow the movement of people and products. Identifying needed repairs and documenting the condition of a building is also important in the private sector, both in protecting the public and in maintaining the value of a building.

Traditionally, structures are inspected by a trained human inspector, who observes and inspects the components of a structure in person. Such in-person inspections often require the inspector to assume potentially dangerous positions, such as being suspended underneath a bridge or adjacent to an exterior portion of a high-rise building. Also, the construction of some structures can present barriers or obstacles, preventing an inspector from achieving a safe vantage point from which to observe the condition of important structural members. The difficulty in safely and accurately maneuvering an inspector, coupled with the fact that most structures have service lives longer than the careers of an inspector, further impedes the ability of inspectors to compile a consistent record of the precise condition of a structure over time.

### SUMMARY

The present invention relates to methods and systems for inspecting structures with a UAV, and using data gathered by the UAV to determine the condition of the inspected structure.

In a first aspect, the invention provides methods for inspecting structures comprising (i) positioning an unmanned air vehicle near a portion of a structure; (ii) acquiring a digital image of the portion of a structure; and (iii) analyzing the image to determine a condition of the portion of a structure. The methods of the first aspect may further comprise positioning the unmanned air vehicle at a predetermined set of coordinates, such as Global Positioning System (GPS) coordinates. The methods of the first aspect may further comprise transmitting the digital image via an air interface to a computer database. In addition to acquiring a digital image, the methods of the first aspect may further comprise acquiring metadata associated with the digital image.

This metadata may include the time the image was acquired, a set of GPS coordinates that correspond to the location of the UAV when the digital image was acquired, and other information, such as a camera configuration, or the altitude of the UAV when the image was acquired. The methods of the first aspect may also comprise acquiring a second digital image at a point in time after the time the first image was acquired. This second digital image may be acquired by positioning the UAV such that the second digital image is acquired from a position substantially similar to a position from which the first digital image was acquired.

In the methods of the first aspect, the analyzing the digital image may comprise comparing the digital image to at least one other image of the same portion of structure. In addition to acquiring a digital image of the structure, the methods of the first aspect may include performing an acoustic test on at least a portion of the structure. The methods of the first aspect may also comprise a sample of a material from at least a portion of the structure.

In a second aspect, the invention provides methods for inspecting structures comprising (i) positioning an unmanned air vehicle at a predetermined position near a portion of a structure; (ii) acquiring a first digital image of the portion of the structure at a first point in time; (iii) collecting a first set of metadata associated with the first digital image; (iv) storing the first digital image and the first set of metadata in a database; (v) acquiring a second digital image of the portion of the structure at a second point in time; (vi) collecting a second set of metadata associated with the second digital image; (vii) storing the second digital image and the second set of metadata in the database; and (viii) analyzing the first digital image and the second digital image to determine a condition of the portion of the structure. In methods of the second aspect, an analyzing the first digital image and the second digital image to determine condition of the portion of the structure may comprise comparing the first digital image to the second digital image and identifying a difference between the first digital image and the second digital image.

For methods of the second aspect, acquiring a second digital image of the portion of the structure may comprise (i) waiting a predetermined interval of time, (ii) placing the unmanned air vehicle in a position substantially similar to the predetermined position; and (iii) capturing a digital image of the portion of the structure. In addition to capturing digital images, the methods of the second aspect may further comprise performing an acoustic test on the portion of the structure and storing a set of data related to the acoustic test in the database.

In a third aspect, the invention provides systems for inspecting a structure comprising: (i) an unmanned air vehicle configured to fly to a position and hover in the position, wherein the unmanned air vehicle is configured to capture a digital image; (ii) a control device configured to communicate wirelessly with the unmanned air vehicle; and (iii) a data storage device configured to communicate with the control device and store a digital image. In systems of the third aspect, the unmanned air vehicle may also be configured to perform an acoustic test on a portion of a structure. The unmanned air vehicle may also be configured to receive instructions from the control device and transmit data to the control device.

These as well as other aspects and advantages will become apparent to those of ordinary skill in the art by reading the following detailed description, with reference where appropriate to the accompanying drawings. Further, it is understood that this summary is merely an example, and is not intended to limit the scope of the invention as claimed.

### BRIEF DESCRIPTION OF FIGURES

FIG. 1 is a flowchart for a method of inspecting structures, according to a first embodiment.

FIG. 2 is a flowchart for a method of inspecting structures, according to a second embodiment.

FIG. 3 is a diagram of a system for inspecting structures, according to a third embodiment.

### DETAILED DESCRIPTION OF EXEMPLARY EMBODIMENTS

Traditionally, inspecting structures such as bridges, highway overpasses, high-rise office towers, and other buildings requires a human inspector to personally observe the condition of the structure. To perform an inspection, the inspector is often suspended from the structure by ropes, harnesses, or other equipment to allow the inspector to view portions of the structure that are not readily seen from other positions. The traditional inspection system can be highly dangerous, especially when the structural integrity of the structure has been compromised. Further, since a structure may be observed by many different inspectors over the life of the structure, it is often difficult to develop an objective record of the condition of the structure. The potential variances among the observations of inspectors are further compounded by the difficulty of consistently viewing the same portion of a structure. For example, even slight changes in the angle or perspective from which an inspector views a structural element may cause different inspectors to come to different conclusions about the condition of a structure.

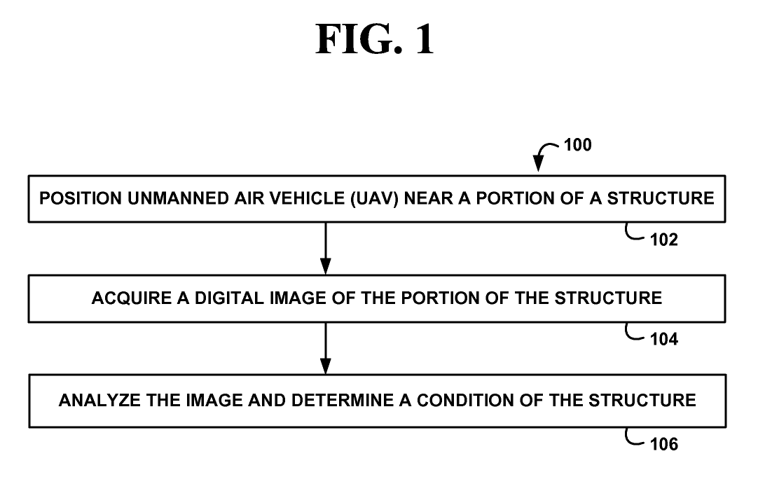

As shown in FIG. 1, a method 100 for structures comprises, positioning an unmanned air vehicle (UAV) near a portion of a structure, shown as block 102, acquiring a digital image of the portion of a structure, shown as block 104, and analyzing the image to determine a condition of the portion of a structure, shown as block 106.

The unmanned air vehicle may be any type of unmanned air vehicle capable of flying to a position and hovering in the position. The unmanned air vehicle may also be any type of unmanned air vehicle capable of hovering in a position and directing a camera or other sensor towards a desired location. The unmanned air vehicle may also be capable of executing flight maneuvers in one area while directing a camera or other sensor towards a desired location. The unmanned air vehicle may also be capable of landing or perching in one position while directing a camera or other sensor towards a desired location.

In one embodiment, the unmanned air vehicle is a ducted fan air vehicle. However, other types of vehicles may also be used, including but not limited to unmanned vertical-take-off-and-landing (VTOL) vehicles, propeller-driven vehicles, vehicles using rotary systems, and vehicles using jet propulsion. Further, the unmanned air vehicle may use any type of energy source, including but not limited to gasoline, diesel, or electricity. By being able to fly to a position and maintain the position, the unmanned air vehicle does not need to be tethered to or suspended from the structure, which permits the unmanned air vehicle to achieve positions near a structure that may be impossible or unsafe for a human inspector to achieve.

In an example implementation of method 100, positioning an unmanned air vehicle near a portion of the structure, shown as block 102, may be accomplished by an operator, who controls the movements of the UAV via a control device which is in wireless communication with the UAV. In such an implementation, the operator may use GPS coordinates and flight information such as altitude to identify a target position for the UAV. However, other methods of positioning the UAV may be used. For example, a flight plan may be preprogrammed into the UAV. In implementations with preprogrammed flight plans, GPS coordinates may also be used to locate the UAV and to identify the target position. Alternatively, signaling beacons that are detectable by sensors on the UAV may be used to identify the position for the UAV.

In block 104, a digital image of a portion of the structure is acquired. In an example implementation of method 100, the UAV is equipped with photographic equipment capable of capturing a digital image, such as a digital camera. After the UAV is in position, the photographic equipment is activated, and the image is acquired. If the UAV is equipped to transmit the acquired image, it may wirelessly transmit the image to a display for viewing and analysis during the inspection of the structure. The UAV, or the control device may also transmit the image to a computer database via an air interface. Alternatively, the UAV may store the image for later retrieval and analysis. Acquiring the digital image may be performed in response to instructions received from an operator via a control device, or the UAV may be configured to capture the image once it achieves the desired position.

After the image is acquired during block 104, the image is analyzed, and a condition of a portion of the structure is determined, as shown in step 106. In an example implementation of method 100, the structural condition of the structure is determined. As used herein, the term “structural condition” means any metric or combination of metrics used to determine the structural safety of the structure. Other conditions of the structure may also be determined. For example, the image may be analyzed to determine the cosmetic condition of the structure, and be used to help determine if any cosmetic repairs or improvements are warranted. Any method for analyzing the image may be used. For example, the operator may view the image and identify indicia of defects or structural abnormalities. In other example implementations of method 100, the acquired image may be compared to reference images of the same portion of the structure, or the acquired image may be compared to the architectural plans for the structure.

Methods such as method 100 may comprise additional elements. For example, implementations of method 100 may also comprise acquiring metadata associated with the digital image. This metadata may include the time the image was acquired, a set of GPS coordinates that correspond to the location of the UAV when the digital image was acquired, and other information, such as a camera configuration, or the altitude of the UAV when the image was acquired, the roll, pitch, and yaw of the UAV when the image was acquired, camera configuration information, and any other information. Such metadata may be used when analyzing an acquired digital image to assist in determining the condition of the structure. For example, precise location information can be used to identify where the particular portion of the structure in the image is located with respect to the rest of the structure. Further, precise location information can be used to ensure the repeatability of the inspection. For example, the GPS coordinates, UAV position information, and camera configuration information associated with one image can be used to develop a flight plan for a subsequent inspection, ensuring that the same portion or portions of the structure are observed in subsequent observations.

Further, implementations of method 100 may include acquiring a second digital image at a point in time after the time the first image was acquired. This second digital image may be acquired by positioning the UAV such that the second digital image is acquired from a position substantially similar to a position from which the first digital image was acquired. As discussed above, metadata associated with the first image may be used to determine the position and configuration of the UAV during the acquisition of the second image.

In implementations where multiple images are taken of the same portion of the structure, analyzing an acquired digital image may comprise comparing the digital image to at least one other image of the same portion of structure. For example, if images of the same portion of a structure are taken periodically over time, a record of any changes in the condition of the structure can be compiled. Where historical images of a structure exist, such as in newspaper archives or other photographic repositories, more recently acquired images can be compared to the historical images to determine if the structure has changed over time. Comparisons to other images may also be used to predict how the condition of the structure may change in the future.

In addition to acquiring a digital image of the structure, the implementations of methods such as method 100 may include performing an acoustic test on at least a portion of the structure. For example, an acoustic test may be performed by striking a portion of the structure and recording any sounds or vibrations produced as a result. In another example, ultrasonic impulses may be applied to a portion of the structure, and the propagation of the impulses through the structure can be recorded. In other implementations, a sample of a material from at least a portion of the structure may be collected by the UAV. For example, samples of corroded materials, paint, or debris may be collected as part of an inspection.

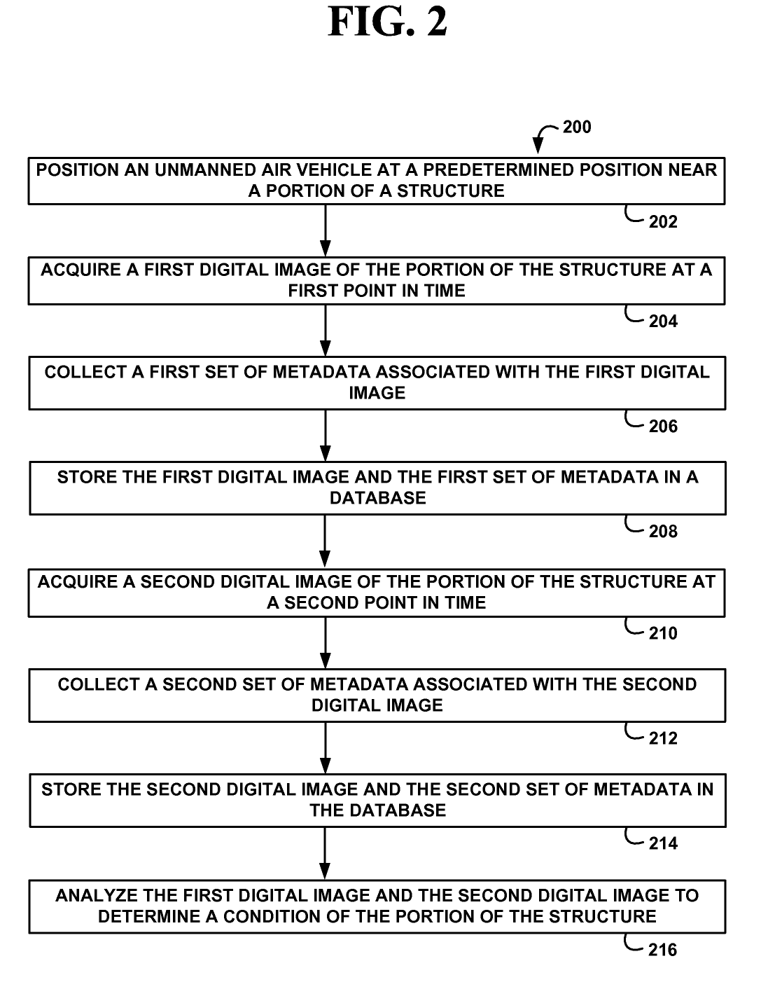

FIG. 2 is a flow chart depicting an example method 200 for inspecting a structure. As shown in block 202, the method comprises positioning an unmanned air vehicle at a predetermined position near a portion of a structure. As discussed previously, any method may be used to position a UAV near a portion of the structure. For example, the UAV may be guided into position by an operator, the UAV may follow a predetermined flight plan, or the UAV may be positioned using signal beacons, or any other means of identifying the position.

As shown by block 204, the method 200 also comprises acquiring a first digital image of the portion of the structure at a first point in time. Similar to block 104 of method 100, the UAV may be equipped with a digital camera, or any other photographic equipment capable of capturing a digital image. In an example implementation a digital camera incorporated into the UAV is activated to acquire a digital image once the UAV is in position.

As shown in block 206, the method 200 also comprises collecting a first set of metadata associated with the first digital image. Any data associated with the digital image may be collected as metadata. For example, information describing the position and orientation of the UAV, the time at which the image was captured, the camera configuration, and other identifying information may be collected.

At block 208, the method 200 comprises storing the first digital image and the first set of metadata in a database. In an example implementation, the database is a computer database configured to allow one or more users to upload and download information such as digital images and metadata. Further, the database may be configured to allow users to search the database for information associated with a particular inspection or a particular structure.

At block 210, the method 200 comprises acquiring a second digital image of the portion of the structure at a second point in time. In example implementations, block 210 may also comprise waiting a predetermined interval of time, placing the unmanned air vehicle in a position substantially similar to the predetermined position; and capturing a digital image of the portion of the structure. Any of the methods used to acquire the first digital image at block 204 may also be used to acquire the second image at block 210.

At block 212, the method 200 comprises collecting a second set of metadata associated with the second digital image. Any of the types of metadata collected at block 206 may be collected at block 212. In an example implementation, the same types or categories of metadata are collected at both block 206 and block 212. However, additional metadata that was not collected in implementations of block 206, either inadvertently or intentionally, may also be collected during block 212.

At block 214, the method 200 comprises storing the second digital image and the second set of metadata in the database. In example implementations, the same database is used to store images and metadata from subsequent inspections of the same portion of a structure. However, any database architecture may be used with method 200.

At block 216, the method 200 comprises analyzing the first digital image and the second digital image to determine a condition of the portion of the structure. In example implementations of method 200, analyzing the first digital image and the second digital image to determine a condition of the portion of the structure may comprise comparing the first digital image to the second digital image and identifying a difference between the first digital image and the second digital image. As with block 106 of method 100, any method for analyzing the digital images may be used. For example, a trained inspector may view the images. In another example implementation, the images are compared using software instructions executed by a computer to identify differences between the first and second images.

In addition to capturing digital images, example implementations of method 200 may further comprise performing an acoustic test on the portion of the structure and storing a set of data related to the acoustic test in the database.

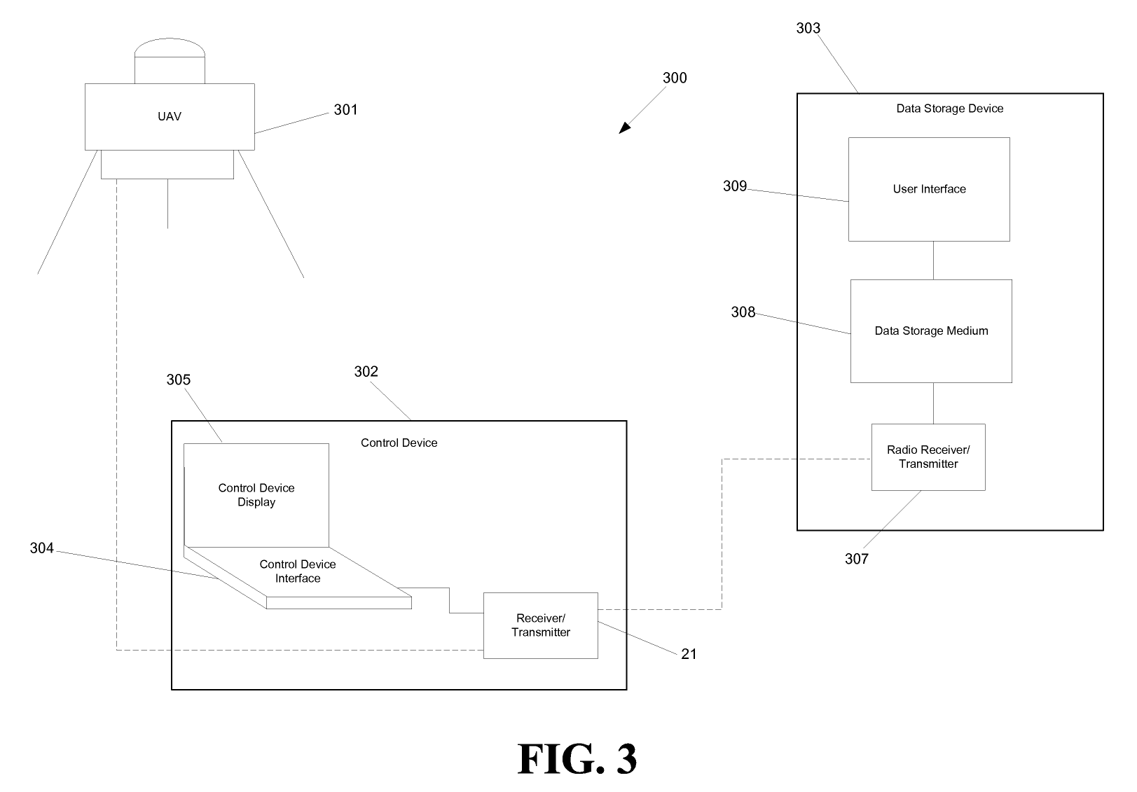

As shown in FIG. 3, a system 300 for inspecting a structure may comprise a UAV 301, a control device 302, and a data storage device 303.

As described above, the UAV 301 may be any type of unmanned air vehicle capable of flying to a position and hovering in the position. For example, UAV 301 may be a ducted fan air vehicle, or may an unmanned vertical-take-off-and-landing (VTOL) vehicle, a propeller-driven vehicle, an unmanned vehicle using jet propulsion, or any other type of unmanned air vehicle.

The UAV 301 is capable of capturing a digital image. For example, a digital camera may be integrated into the unmanned air vehicle. In other example embodiments, a digital video camera is integrated or attached to the UAV 301. In other example embodiments, the UAV is configured with a camera capable of recording wavelengths of light outside the visible spectrum, such as infrared or ultraviolet radiation. The UAV 301 may be in communication with the control device 302. For example, the UAV 301 may be configured to communicate with the control device 302 via radio transmissions or other wireless communications, such as long-range wireless internet data transfer, or via GSM or CDMA networks. If in communication with the control device 302, the UAV may also be configured to transmit a digital image to the control device 302.

The control device 302 may be used by an operator to transmit data to the UAV 301 and to receive data from the UAV 301. For example, an operator may control the flight and operation of the UAV 301 by transmitting commands to the UAV 301 from the control device 302. In an example embodiment, the control device 302 is a rugged tablet computer. However, any device capable of communicating wirelessly with the unmanned air vehicle may be used, including but not limited to handheld computers, laptop or notebook computers, or other similar devices. As depicted in FIG. 3, control device 302 may include a user interface 304 and a display 305. In embodiments where the control device 302 has a display 305, digital images captured by the UAV 301 may be transmitted to and viewed on the control device 302. The control device 302 is also equipped with a receiver/transmitter 306.

The receiver/transmitter 306 may be a stand-alone radio receiver/transmitter, or it may be a device incorporated into the control device 302. The receiver/transmitter 306 is capable of sending data, such as instructions, to the UAV 301. The receiver/transmitter 306 is also capable of transmitting data to the data storage device 303. The receiver/transmitter 306 may also be capable of receiving transmissions from the UAV. For example, the UAV may transmit digital images, metadata associated with a digital image, or flight data to the control device 302. The receiver/transmitter 306 may also be capable of receiving data transmitted from the data storage device 303. For example, an operator may request a digital image or flight data from a previous inspection that is stored in the data storage device 303, and compare the data from a previous inspect to the data compiled during another inspection.

System 300 also comprises data storage device 303. As depicted in FIG. 3, data storage device 303 may include radio receiver/transmitter 307, data storage medium 308, and user interface 309. Data storage device 303 is capable of communicating wirelessly with the control device 302. In the example depicted in FIG. 3, radio receiver/transmitter 307 is used to communicate with the control device 302. Radio receiver/transmitter 307 may be a discrete device, or it may be integrated into the data storage device 303. Further, any communication technique or protocol that can be used to transmit data from the control device 302 to the UAV 301 may be used to transmit data from the control device 302 to the data storage device 303.

The data storage device 303 includes a data storage medium 308 capable of storing digital images, metadata, and other information compiled during or associated with an inspection of a structure. For example, a record stored in the data storage device 308 may include a captured image, the time the image was taken, the date of the inspection, GPS coordinates of the unmanned air vehicle when the image was captured, or other position data such as the altitude, roll, pitch, and yaw of the unmanned air vehicle when the image was captured. The database record may also include information about how the image was captured, such as the position of a camera relative to the unmanned air vehicle, and other information such as the magnification factor of any optical elements used, the size of the image, or other information describing the operation of a camera. The record stored in data storage device 308 may also include information such as an inspector's notes, observations, and conclusions regarding the content of the image, or other observations about the condition of the structure. In an example embodiment, the data storage medium 308 comprises one or more computer hard drives. However, any type of memory element capable of storing and retrieving digital data may be used as part of data storage medium 308.

The data storage device 303 may also comprise a user interface 309. The user interface 309 may be configured to allow a user to retrieve, view, modify, upload, and store data to the data storage device 303. In an example embodiment, the user interface is a computer integrated with the data storage device 303. In other example embodiments the user interface 309 is a computer connected to data storage device 303 via a network or a server.

Various arrangements and embodiments in accordance with the present invention have been described herein. It will be appreciated, however, that those skilled in the art will understand that changes and modifications may be made to these arrangements and embodiments, as well as combinations of the various embodiments without departing from the true scope and spirit of the present invention, which is defined by the following claims.

What is claimed:

1. A method for inspecting structures comprising:
positioning an unmanned air vehicle near a portion of a structure;
acquiring a digital image of the portion of a structure; and
analyzing the image to determine a condition of the portion of a structure.

2. The method of claim 1 wherein positioning an unmanned air vehicle near a portion of a structure comprises positioning the unmanned air vehicle at a predetermined set of coordinates.

3. The method of claim 1 further comprising transmitting the digital image via an air interface to a computer database.

4. The method of claim 1 further comprising acquiring metadata associated with the digital image.

5. The method of claim 4 wherein acquiring metadata associated with the digital image comprises identifying a time when the digital image was acquired.

6. The method of claim 4 wherein acquiring metadata associated with the digital image comprises identifying a set of Global Positioning System (GPS) coordinates that correspond to the location of the unmanned air vehicle when the digital image was acquired.

7. The method of claim 4 wherein acquiring metadata associated with the digital image comprises information describing a camera configuration used to acquire the digital image.

8. The method of claim 4 wherein acquiring metadata associated with the digital image comprises information describing the altitude of the unmanned air vehicle at the time the digital image was acquired.

9. The method of claim 1 further comprising acquiring a second digital image at a point in time after the time the first image was acquired.

10. The method of claim 9 wherein acquiring a second digital image at a point in time after the time the first image was acquired further comprises positioning an unmanned air vehicle with a digital camera such that the second digital image is acquired from a position substantially similar to a position from which the first digital image was acquired.

11. The method of claim 9 wherein analyzing the digital image comprises comparing the digital image to at least one other image of the same portion of structure.

12. The method of claim 1 further comprising performing an acoustic test on at least a portion of the structure.

13. The method of claim 1 further comprising collecting a sample of a material from at least a portion of the structure.

14. A method for inspecting structures comprising:
positioning an unmanned air vehicle at a predetermined position near a portion of a structure;
acquiring a first digital image of the portion of the structure at a first point in time;
collecting a first set of metadata associated with the first digital image;
storing the first digital image and the first set of metadata in a database;
acquiring a second digital image of the portion of the structure at a second point in time;
collecting a second set of metadata associated with the second digital image;
storing the second digital image and the second set of metadata in the database; and
analyzing the first digital image and the second digital image to determine a condition of the portion of the structure.

15. The method of claim 14 wherein analyzing the first digital image and the second digital image to determine condition of the portion of the structure comprises:
comparing the first digital image to the second digital image; and
identifying a difference between the first digital image and the second digital image.

16. The method of claim 14 wherein the acquiring a second digital image of the portion of the structure comprises:
waiting a predetermined interval of time;
placing the unmanned air vehicle in a position substantially similar to the predetermined position; and
capturing a digital image of the portion of the structure.

17. The method of claim 14 further comprising:
performing an acoustic test on the portion of the structure; and
storing a set of data related to the acoustic test in the database.

18. A system for inspecting a structure comprising:
an unmanned air vehicle configured to fly to a position and hover in the position, wherein the unmanned air vehicle is configured to capture a digital image;
a control device configured to communicate wirelessly with the unmanned air vehicle; and
a data storage device configured to communicate with the control device and store a digital image.

19. The system of claim 18 wherein the unmanned air vehicle is further configured to perform an acoustic test on a portion of a structure.

20. The system of claim 18 wherein the unmanned air vehicle is further configured to:
receive instructions from the control device; and
transmit data to the control device.
